(19) United States
(12) Patent Application Publication
(10) Pub. No.: US 2017/0257521 A1
(43) Pub. Date: Sep. 7, 2017

(54) ELECTRONIC APPARATUS AND DISPLAY METHOD OF ELECTRONIC APPARATUS

(71) Applicant: Seiko Epson Corporation, Tokyo (JP)

(72) Inventors: Junichi TAKENUKI, Sapporo-shi (JP); Hiroyuki TSUJI, Matsumoto-shi (JP)

(73) Assignee: Seiko Epson Corporation, Tokyo (JP)

(21) Appl. No.: 15/445,032

(22) Filed: Feb. 28, 2017

(30) Foreign Application Priority Data
Mar. 1, 2016 (JP) 2016-038649

(51) Int. Cl. H04N 1/393; H04N 1/00; G06T 3/40

(52) U.S. Cl. CPC H04N 1/393; G06T 3/40; H04N 1/00469; H04N 1/00411; G06F 3/04845

(57) ABSTRACT

A data providing unit configured to provide document data including a plurality of objects, an image creating unit configured to generate image data including at least one of the objects arranged on an image plane based on the document data, and a display unit configured to display the image data are provided. The image creating unit generates the image data corresponding to a first image and the image data corresponding to a second image which corresponds to an image obtained by reducing the first image by a prescribed reduction ratio, and the image creating unit sets a size of a priority object selected from the objects based on an attribute in the document data of the second image to be greater than a size obtained by multiplying a size of the priority object in the first image by the reduction ratio.

### BACKGROUND

1. Technical Field

The present invention relates to a technique for enabling a display included in an electronic apparatus to display an image and more particularly to display of an image in a reduced manner.

2. Related Art

Some electronic apparatuses are provided with displays to present various types of information to users. However, because of the structures of the electronic apparatuses, in some cases, the size of a screen to be provided may be insufficient for displaying all necessary information. In such cases, an image is enlarged or reduced as necessary to achieve easy-to-view display of information requested by a user. For example, JP-A-2014-010719 discloses a technique for collapsing and expanding layered menu items by performing a pinch zoom operation on a touch panel of a tablet terminal.

The above-referenced technique is to enlarge or reduce a layered menu image. However, there are cases where an image including a plurality of objects arranged on an image plane also has to be displayed in an enlarged or reduced manner. In such cases, the collapsing and the expanding as described above cannot be adopted, and each object has to be enlarged or reduced. In particular, when an image is to be reduced and displayed, uniformly reducing the entire image by, for example, eliminating dots included in the image at a constant ratio may reduce the legibility of the image, for example, may render text in the image no longer legible.

### SUMMARY

Some aspects according to the present invention provide a technique by which even a reduced image can be displayed with good legibility in an electronic apparatus which has a configuration capable of solving at least some of the above-mentioned problems and includes a display.

One aspect of the invention is an electronic apparatus including: a data providing unit configured to provide document data including a plurality of objects; an image creating unit configured to generate image data including at least one of the objects arranged on an image plane based on the document data; and a display unit configured to display the image data, wherein the image creating unit generates the image data corresponding to a first image and the image data corresponding to a second image which corresponds to an image obtained by reducing the first image by a prescribed reduction ratio, and the image creating unit sets a size of a priority object selected from the objects based on an attribute in the document data of the second image to be greater than a size obtained by multiplying a size of the priority object in the first image by the reduction ratio.

Moreover, another aspect of the invention is a display method of an electronic apparatus, the display method including: generating image data in which at least some objects included in document data are arranged on an image plane; and displaying the generated image data on a display, wherein the image data corresponding to a first image and the image data corresponding to a second image which corresponds to an image obtained by reducing the first image by a prescribed reduction ratio is generated, and a size of a priority object selected from the objects based on an attribute in the document data of the second image is set to be greater than a size obtained by multiplying a size of the priority object in the first image by the reduction ratio.

With this configuration, the priority object in the reduced image is displayed bigger than that in a case where the image is reduced by a uniform reduction ratio. Therefore, the priority object is enhanced in the reduced image and can thus be displayed with good legibility. The priority object is selected based on the attribute in the document data, and therefore, an object arranged in the document with specific intentions can be the priority object. Thus, in a reduced image in which it is difficult to determine details, the main information of the image can be preferentially retained.

Objects other than the priority object may be processed, for example, such that the size of at least some of the objects other than the priority object in the second image may be set to be smaller than a size obtained by multiplying the size of at least some of the objects in the first image by the reduction ratio. Alternatively, for example, at least some of the objects other than the priority object may be hidden in the second image. With these configurations, the priority object is more enhanced, which can further improve the legibility of the priority object in the second image.

Moreover, for example, the above-described electronic apparatus may include a reception unit configured to receive an input operation to change the reduction ratio, wherein the reduction ratio may be set according to the input operation to the reception unit. For example, a touch panel serving as the reception unit and the display unit may be provided, wherein the input operation may be a pinch zoom operation performed on the touch panel. With this configuration, an image with good legibility can be displayed at a reduction ratio desired by a user.

Moreover, for example, when the document data includes text as the objects, a portion of the text selected based on text attributes in the document data may be defined as the priority object. With this configuration, the entire document is reduced while the part of the text in the document is enhanced, which enables the readability of the text to be maintained. As the text attribute effective to select the priority object, for example, the typeface and/or size of text characters, the position of the text in the document, and character decorations can be used.

Moreover, for example, a printer unit configured to execute a printing operation may be provided, and the data providing unit may be configured to store the document data corresponding to a guidance screen explaining operation of the printer unit. An electronic apparatus whose main purpose is printing cannot always be provided with a large size display unit due to limitations such as installation space and apparatus cost. Therefore, a relatively small display unit has to display information requested by a user. In this case, reducing an image enables more pieces of information to be displayed but reduces the readability of each character. In such a case, the invention is applied to enhance, for example, index items as priority objects, so that required items are more obvious to the user.

Not all of the plurality of elements of the above-described respective aspects of the invention are essential. In order to solve some or all of the above-described problems or in order to achieve some or all of the advantages described in the specification, some of the elements may be appropriately changed, deleted, replaced by new elements, or some limitations may be deleted. Further, in order to solve some or all of the above-described problems or in order to achieve some or all of the advantages described in the specification, some or all of the technical features contained in the above-described one aspect of the invention may be combined with some or all of the technical features contained in the above-described other aspects of the invention into one independent aspect of the invention.

### BRIEF DESCRIPTIONS OF THE DRAWINGS

The invention will be described with reference to the accompanying drawings, wherein like numbers reference like elements.

FIG. 1 is a view illustrating the exterior of an electronic apparatus of a first embodiment according to the present invention.

FIG. 2 is a block diagram illustrating the electrical structure of the electronic apparatus of the first embodiment.

FIG. 3 is a flowchart illustrating a viewer process.

FIG. 4 is a view illustrating a display area of an image.

FIG. 5 is a view illustrating a method for reducing a text image.

FIG. 6 is a view illustrating an example of points according to attributes.

FIG. 7 is a view illustrating the exterior of an electronic apparatus of a second embodiment according to the invention.

FIG. 8 is a block diagram illustrating the electrical structure of the electronic apparatus of the second embodiment.

### DESCRIPTION OF EXEMPLARY EMBODIMENTS

### First Embodiment

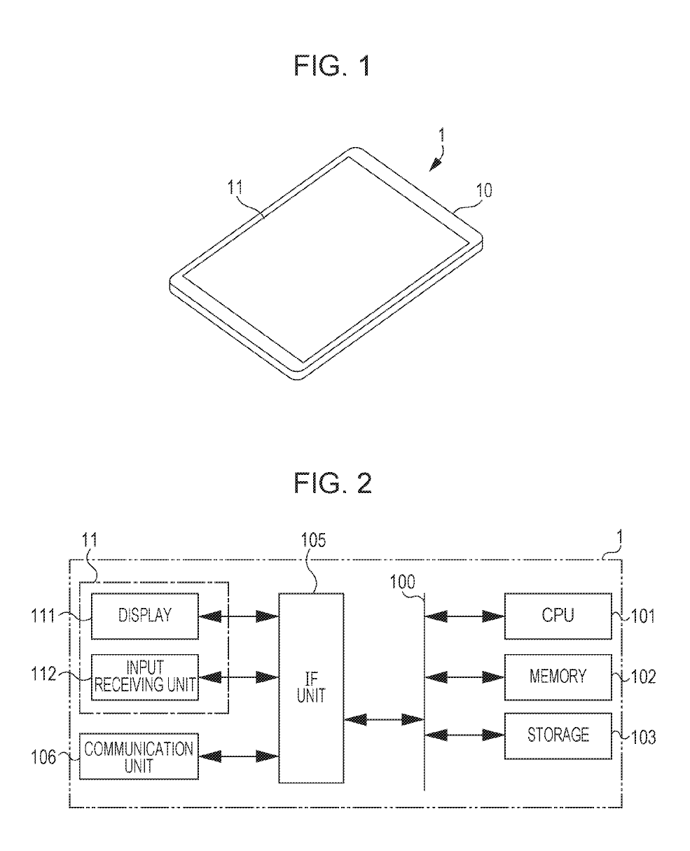

FIG. 1 is a view illustrating the exterior of an electronic apparatus of a first embodiment according to the present invention. An electronic apparatus 1 is a portable computer which runs various applications and is a so-called tablet terminal apparatus. Other electronic apparatuses having similar configurations are, for example, a Personal Digital Assistant or a Personal Data Assistant (PDA; portable information terminal), an electronic book reader, and an electronic paper to which the invention is applicable. Moreover, the technical concept of the invention is also applicable to various electronic apparatuses such as a printer, which will be described later.

The tablet terminal apparatus 1 includes a tabular housing 10 having an upper surface of which almost the entire area serves as a touch panel 11. The touch panel 11 displays an image according to an application run by the tablet terminal apparatus 1 to provide various types of information to a user and receives an input operation as a result of being pressed by a user.

FIG. 2 is a block diagram illustrating the electrical structure of the electronic apparatus. As illustrated in FIG. 2, the tablet terminal apparatus 1 includes a CPU 101, memory 102, storage 103, an interface (IF) unit 105, and other elements, and these elements are connected to be able to communicate with each other via an internal bus 100.

The CPU 101 runs a predetermined program to enable the elements of the apparatus to perform prescribed processes. The memory 102 stores various data such as data required to perform the processes and intermediate data generated by the CPU 101. The storage 103 has a larger storage capacity than the larger memory 102 and enables non-volatile data storage. The storage 103 stores a program run by the CPU 101 and various types of data such as document data generated by running the program or provided by an external device.

The IF unit 105 controls exchange of information between the tablet terminal apparatus 1 and a user and an external device. Specifically, the touch panel 11 and a communication unit 106 are connected to the IF unit 105. The touch panel 11 includes a display unit 111 configured to display an image and an input receiving unit 112 configured to output a signal corresponding to a touch position on a display surface of the display unit 111 to accept a touch operation. Contents of an image to be displayed on the display unit 111 are determined by display data received from the CPU 101 provided via the IF unit 105. Moreover, the signal output from the input receiving unit 112 and relating to the touch position is transmitted via the IF unit 105 to the CPU 101. With this configuration, the CPU 101 can grasp the content of an input operation performed by a user on the touch panel 11. The communication unit 106 has a wired or wireless communication function and communicates with an external device via a suitable form of communication such as the Internet or via wireless communication.

The tablet terminal apparatus 1 having the above-described configuration is capable of executing various processes when provided with suitable applications. An example of the various processes is a viewer function in which contents of a document file stored in the storage 103 in advance or acquired by the communication unit 106 from an external device are presented as an image to be viewed by a user. A viewer process executed by the tablet terminal apparatus 1 to realize this function will be described below. This process is realized by the CPU 101 running a program stored in the storage 103 in advance.

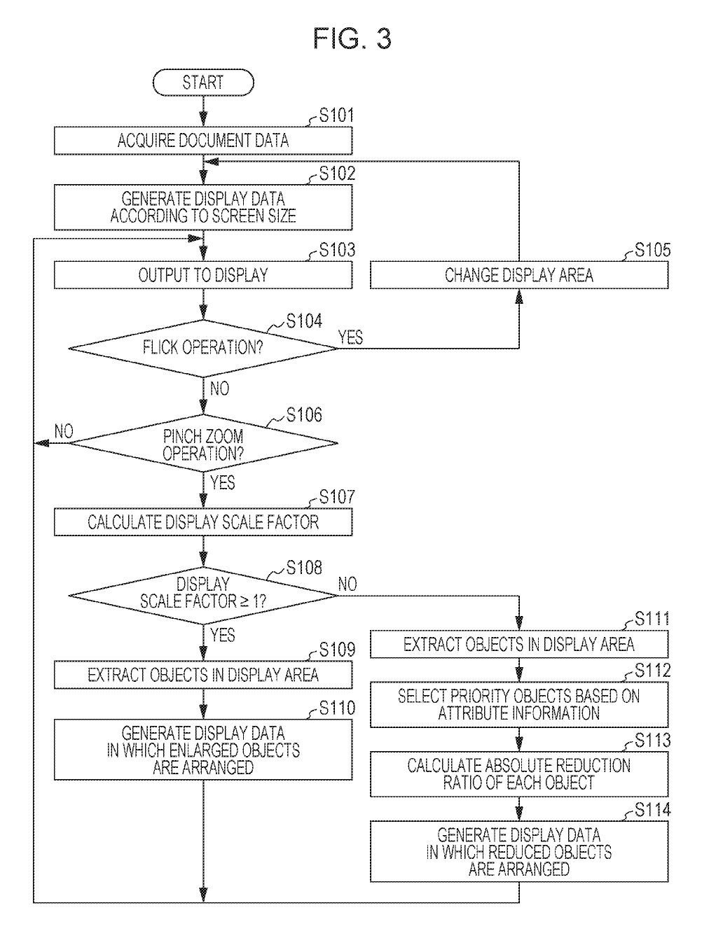

FIG. 3 is a flowchart illustrating the viewer process. When a user performs an operation of opening a document file to be displayed, the CPU 101 acquires from the storage 103 or an external device (step S101) document data representing image content in the document file and stores the acquired document data in the memory 102. The document data stored in the memory 102 may be a portion of the document data included in the document file.

The CPU 101 performs processing to arrange objects within an area corresponding to a screen size of the display unit 111 of the touch panel 11, of the image represented by the acquired document data, on an image plane corresponding to the screen size in a layout specified by the document data, thereby generating display data (step S102). The display data is output from the CPU 101 via the IF unit 105 to the display unit 111, thereby displaying an image corresponding to the display data on the display unit 111 (step S103).

When the image represented by the document data does not fit the screen size of the display unit 111, display data representing only a part of the image is generated. To view the entire image, a user can change the contents of the image to be displayed by performing an input operation on the touch panel 101. Specifically, a finger in contact with the touch panel 101 is slid (a flick operation or a swipe operation is performed), thereby scrolling the image and/or switching display pages. Additionally or alternatively, a space between two fingers in contact with the touch panel 101 is reduced (a pinch operation is performed) or increased (a zoom operation is performed), thereby reducing or enlarging the image.

The input receiving unit 112 receives the flick operation (or the swipe operation) performed by a user on the touch panel 11 (step S104), and then, according to the degree of the operation, a display area to be displayed on the display unit 111, of the image represented by the document data, is changed (step S105). Then, display data of the changed display area is newly generated (step S102), and the generated display data is output to the display unit 111 (step S103). In this way, a screen is scrolled or pages are switched.

When the input receiving unit 112 receives the pinch operation or the zoom operation (hereinafter collectively referred to as a “pinch zoom operation”) performed by a user on the touch panel 11 (step S106), an image enlargement or reduction process is performed. Here, the meaning of each of the terms “enlargement”, “reduction” and “display scale factor” in the specification will be described.

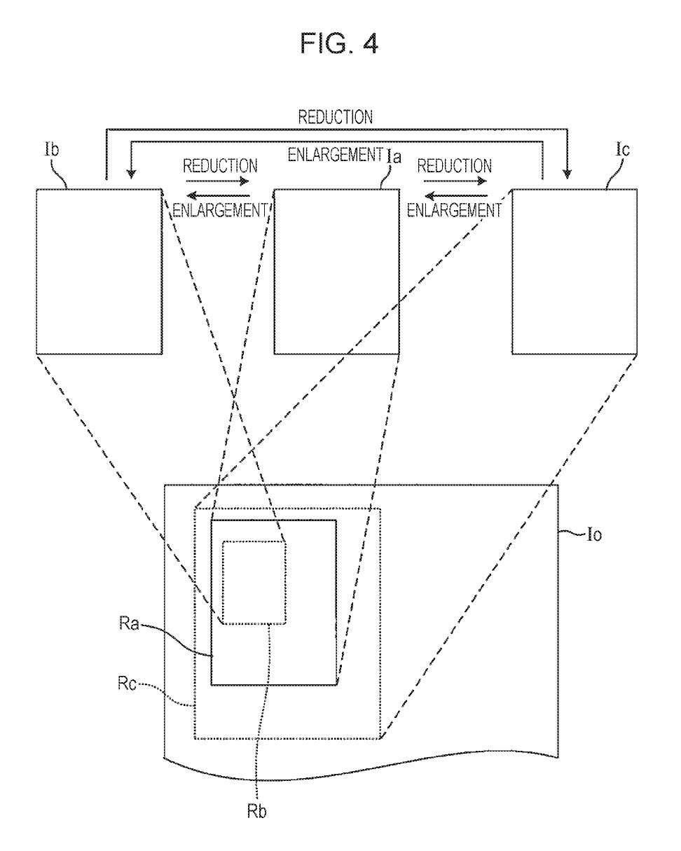

FIG. 4 is a view illustrating a display area of an image. In a default state immediately after a document file is opened, display data is generated in which, of an original image Io including objects having layouts and attributes specified by document data, objects within a region Ra corresponding to the screen size of the display unit 111 are arranged in a specified size and in a specified layout, and an image Ia corresponding to the display data is displayed on the display unit 111. In the image Ia, the objects are displayed in the size specified in the original image Io, and the display scale factor at this time is defined as 1. Moreover, the image Ia at this time is referred to as an “original-size image”.

A user performs the zoom operation on the touch panel 11 with the image Ia being displayed on the display unit 111, thereby enlarging the image. Specifically, an area of the original image Io reflected by the display data is limited to a region Rb smaller than the region Ra, while the display data is generated with each of the objects in the region Rb being more enlarged than in the image Ia. In this way, an image Ib corresponding to an enlarged image of the region Rb is displayed on the display unit 111. At this time, the display scale factor is greater than 1. When the display scale factor is greater than 1, the display area is smaller than when the display scale factor is 1, which results in a large size of each of the objects.

A user performs the pinch operation with the image Ia being displayed on the display unit 111, thereby reducing the image. Specifically, display data is generated with the area of the original image Io reflected by the display data being enlarged to fit a region Rc larger than the region Ra and each of the objects in the region Rc being more reduced than in the image Ia. In this way, an image Ic corresponding to the reduced image of the region Rc is displayed on the display unit 111. At this time, the display scale factor is less than 1. When the display scale factor is less than 1, the display area is larger than when the display scale factor is 1, which results in a small size of each of the objects.

As described above, changing the original-size image Ia corresponding to the original image Io and having a display scale factor of 1 with respect to the image Ib having a display scale factor greater than 1 corresponds to the “enlargement” of an image. The “display scale factor” is a value for indexing extent to which the display area after enlargement or reduction is contracted or expanded with respect to the display area in the original-size image Ia. Moreover, changing the original-size image Ia corresponding to the original image Io and having a display scale factor of 1 with respect to the image Ic having a display scale factor less than 1 corresponds to the “reduction” of an image. The enlargement and the reduction in this case are based on the image Ia having a display scale factor of 1 as a reference and can be respectively referred to as “absolute enlargement” and “absolute reduction”.

However, a change of the image Ib with respect to the image Ic also corresponds to “reduction”, whereas a change of the image Ic with respect to the image Ib corresponds to “enlargement”. More generally, a change in a direction in which the display scale factor increases and the display area contracts is “enlargement”, whereas a change in a direction in which the display scale factor decreases and the display area expands is “reduction”. These directions are directions of relative change of the display scale factor before and after the enlargement or the reduction, and in this sense, the enlargement and the reduction in this case can be referred to as “relative enlargement” and “relative reduction”.

Similarly, “enlargement ratio” or “reduction ratio” representing the extent of the enlargement or the extent of the reduction may have two types of definition, an absolute definition and a relative definition. In this specification, simple use of the term “enlargement ratio” or “reduction ratio” shall denote the relative definition. That is, when an image is enlarged, the ratio of the display scale factor of the image after the enlargement to the display scale factor of the image before the enlargement is referred to as the “enlargement ratio”. Moreover, when an image is reduced, the ratio of the display scale factor of the image after the reduction to the display scale factor of the image before the reduction is referred to as the “reduction ratio”. Thus, as the size of an object after the reduction with respect to the size of the object before the reduction decreases, the value of the reduction ratio decreases. That is, between an image having a “small reduction ratio” and an image having a “large reduction ratio”, the size of an identical object is larger in the image having the “large reduction ratio”. When the original-size image Ia is used as a reference, the enlargement ratio of an image after the enlargement and the reduction ratio of the image after the reduction are equal to the display scale factor.

Referring back to FIG. 3, the description of the viewer process will be continued. The pinch zoom operation is received by the input receiving unit 112 at step S106, and then, according to the degree of the operation, the CPU 101 calculates the display scale factor of an image to be displayed (step S107). The degree of the pinch zoom operation is, for example, the degree of change in space between two fingers in contact with the touch panel 11. The magnitude of the degree of change is deemed to be an indication of intention of a user as to the extent of the enlargement and the reduction. The display scale factor is an absolute value based on the original image Io as a reference. To avoid accumulation of degradation in image quality caused by repeating the enlargement or reduction of an image, a display data generation process for enlarging or reducing an image is performed based on the original document data.

However, the pinch operation or the zoom operation performed by a user is performed with an expectation that a reduced or enlarged image relative to a currently displayed image be displayed. Thus, display data generated according to the pinch zoom operation has to reflect the display scale factor of a display image before the operation and the relative enlargement ratio or the relative reduction ratio specified by the pinch zoom operation.

Specifically, for the pinch operation to reduce an image, the display scale factor after the reduction may be a value obtained by multiplying a current display scale factor by the degree of the operation performed by a user, that is, a coefficient proportional to the amount of decrease in space between two fingers in contact with the touch panel 11. For the zoom operation to enlarge an image, the display scale factor after the enlargement may be a value obtained by multiplying a current display scale factor by the degree of the operation performed by a user, that is, a coefficient proportional to the amount of increase in space between two fingers in contact with the touch panel 11.

A subsequent process depends on whether or not a required display scale factor is greater than or equal to 1 (step S108). A process in a case of the display scale factor being greater than or equal to 1 (Yes at step S108) is first described. The CPU 101 extracts objects included in a display area of the original image Io specified by the display scale factor (step S109) and generates display data representing an image in which the objects enlarged according to the display scale factor are arranged in an image plane corresponding to a screen size (step S110). The thus generated display data is given to the display unit 111, thereby displaying an enlarged image. In this case, each object is enlarged by an absolute enlargement ratio which is the same as the display scale factor. Thus, the image after the enlargement is an image including uniformly enlarged objects.

On the other hand, when the display scale factor is less than 1, i.e., absolute reduction is required, the absolute reduction ratio of objects is not uniform. That is, the CPU 101 extracts objects included in a display area of the original image Io specified by the display scale factor (step S111) in a similar manner as in the case of enlargement but selects some of the objects as priority objects and makes the absolute reduction ratio different between the priority objects and objects other than the priority objects.

Specifically, based on pieces of attribute information given to the objects in the display area, the CPU 101 selects priority objects from the objects (step S112). Then, the CPU 101 scales down the priority objects and objects other than the priority objects by different absolute reduction ratios (step S113) and generates display data corresponding to an image in which these objects are arranged in an image plane (step S114). The thus generated display data is given to the display unit 111, thereby displaying a reduced image on the display unit 111.

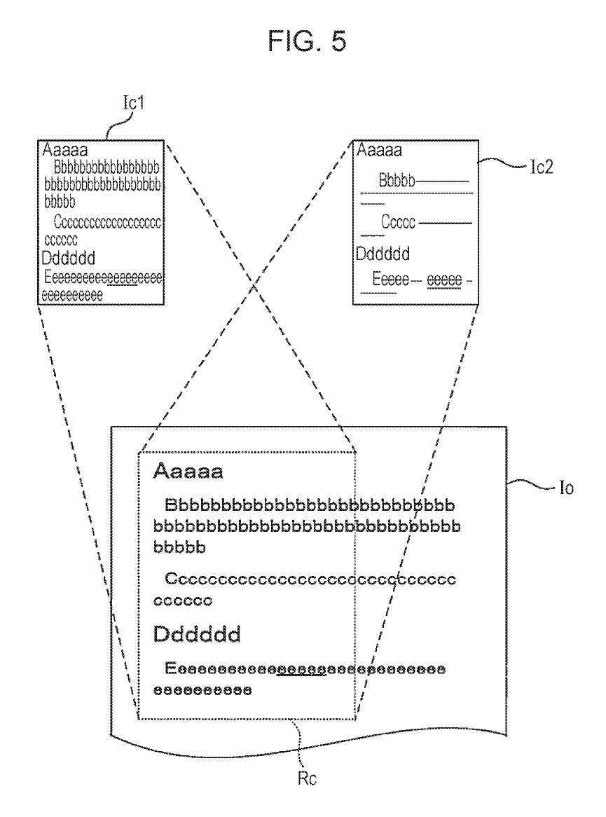

FIG. 5 is a view illustrating a method for reducing a text image. A reason why the reduction ratio is made different between objects in a case of the display scale factor being less than 1 will be described with reference to FIG. 5. As illustrated in FIG. 5, a case where the original image Io is an image in which a plurality of text objects are arranged in an image plane will be considered as an example. Here, each character of the text may be configured as one object, or one paragraph including a plurality of characters may configure one object. The original image Io of FIG. 5 is a text image including both headlines “Aaaaa” and “Dddddd” including relatively large characters and paragraphs including relatively small characters.

When a part, the region Rc, of such an original image is to be reduced and displayed on the display unit 111, reducing all objects with a uniform reduction ratio may result in an image Ic1 as illustrated in the figure in which all characters are small and hardly read. In particular, when a display screen has a relatively rough dot matrix, increasing the extent of the reduction may completely collapse characters and may results in indecipherable characters. When a user attempts to display an image in a reduced manner in a limited display space, in many cases, the user attempts to comprehensively view which contents the whole image includes, and it may be sufficient that a main part of the text is fragmentally legible even if individual characters are not legible.

Thus, in the present embodiment, attributes of the text objects in the display area are acquired from attribute information owned by the document data, and the reduction ratio of the objects is made different according to the attribute. That is, as shown as an image Ic2, the headlines or some characters at the beginning of sentences which are estimated to representatively express the contents of the document are relatively large, and other characters are relatively small or omitted. In this way, the whole image is reduced by the specified display scale factor, but the main part of the document is maintained with good legibility. At this time, examples of an elliptical expression in a case of ellipsis include blank display or a symbol showing the ellipsis, and when a plurality of elliptical expressions continue, an elliptical expression collectively expressing the plurality of elliptical expressions may be displayed.

In order to keep good legibility of the priority objects in the reduced image, for example, the reduction ratio of the priority objects may be made greater than the reduction ratio of the whole image. This means that the reduction of the priority objects is limited to a lesser extent than in a case where objects in the image are reduced by a uniform reduction ratio, thereby resulting in a relatively large display of the priority objects. In this way, the priority objects are displayed while being emphasized in the reduced image, and good legibility of the priority objects can be kept.

Specifically, the size of the priority objects in the reduced image Ic2 may be made larger than a value obtained by multiplying the size of the priority objects in the original-size image Ia by the reduction ratio of the reduced image Ic2 based on the original-size image Ia as a reference, that is, the display scale factor. In this way, the size of the priority objects becomes relatively large with respect to the entirety of the reduced image, and the legibility of the priority objects can be kept better than in a case of uniform reduction.

A selection criterion of the priority objects will be described. Many documents intended to be displayed on a screen are not in a plain text format including simple strings of text characters but in a data format in which the attributes, such as the size and the arrangement, of characters are set generally by using appropriate software for editing documents with a specific intention. Thus, from the attribute given to each text object, main objects can be selected as the priority objects.

For example, many objects provided with paragraph attributes, such as titles, subtitles, and headlines express contents of a document straightforward. Therefore, these objects are considered to be effective as the priority objects. Moreover, for example, an object having a typeface, a size, a color, and the like different from those of other objects and an object provided with character decorations such as a bold face, an italic face, and an underline have special meanings in the document. Moreover, for example, beginning sections of paragraphs may include important contents. These objects are also effective as the priority objects.

In addition, objects constituting links (hyperlinks) to, for example, other locations in the document or other files, diagrams between the text objects, etc. can also be characteristic in the document. Therefore, these objects are also effective as the priority objects.

In this way, based on the attribute given to each object, objects provided with special meanings in the document can be selected as priority objects. A relatively small extent of the reduction of the priority objects in reducing the image enables the legibility of the priority objects to be kept good also in the reduced image.

Objects other than the priority objects are preferably less outstanding than the priority objects in the reduced image. Therefore, for example, the size of at least one of the objects other than the priority objects in the reduced image Ic2 may be reduced to be less than a value obtained by multiplying the size of the object in the original-size image Ia by the display scale factor. Moreover, the size of at least one object may be set to zero, that is, may be set such that the object is not displayed in the reduced image. In this way, the reduced image mainly includes the priority objects, and the legibility of the priority objects can be further improved. In the reduced image Ic2 shown in FIG. 5, the objects other than the priority objects are shown as simple lines.

From the point of view of the legibility of the reduced image, the number of objects to be priority objects in objects in the display area has to be optimal. If the number of priority objects arranged in the reduced image is too large, interference of the objects with each other actually reduces the legibility, whereas if the number of priority objects is too small, the outline of the image cannot be delivered to a user.

An example method for selecting an optimal number of priority objects includes, as described below, calculating points according to the attribute of each object in the display area, and weighting each object based on the level of the point.

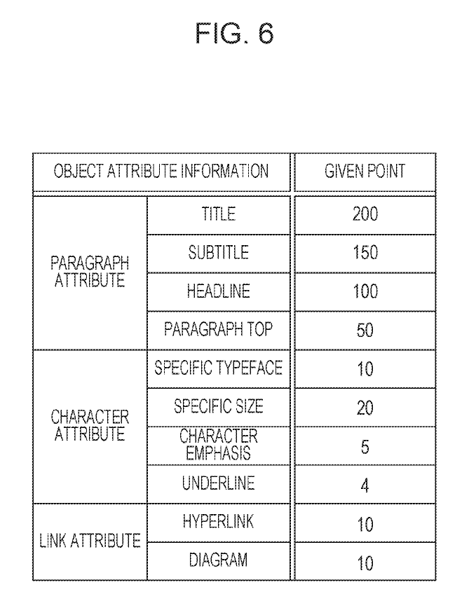

FIG. 6 is a view illustrating an example of points according to attributes. Each object in the display area is given points as shown in FIG. 6 according to the attribute of the object. When one object has a plurality of attributes, points of the attributes are added. In this way, a total point is obtained for each object in the display area. The larger the point of the object is, the more important contents the object has in the document, and the object is assumed to have a higher priority. Therefore, it is only required to define objects having relatively large points in the display area as the priority objects.

Objects to be defined as the priority objects are objects whose total points are greater than or equal to a prescribed value, objects whose priority ranks based on the total points are within a range of a prescribed number from the top rank, and other objects. The “predetermined number” at this time can be a value obtained by multiplying the number of objects included in the display area by a fixed ratio. Moreover, depending on which attribute each object in the display area has, the given point may be dynamically set. Moreover, depending on a program configured to generate document data, used attribute information and given points may be changed.

As described above, in the present embodiment, in an image displayed in a reduced manner with respect to the original-size image, objects in the display area are not uniformly reduced, but some of the objects are selected as priority objects, and the priority objects are displayed relatively largely with respect to the reduction ratio of the whole image. In this way, the priority objects are displayed while being more enhanced than other objects in the reduced image, and the legibility can be kept better than that in a case of uniform reduction. The priority objects are selected based on the attributes of the objects, and therefore, defining objects having important meanings in the image as the priority objects enables a user to easily understand the outlines of contents of the reduced image.

### Second Embodiment

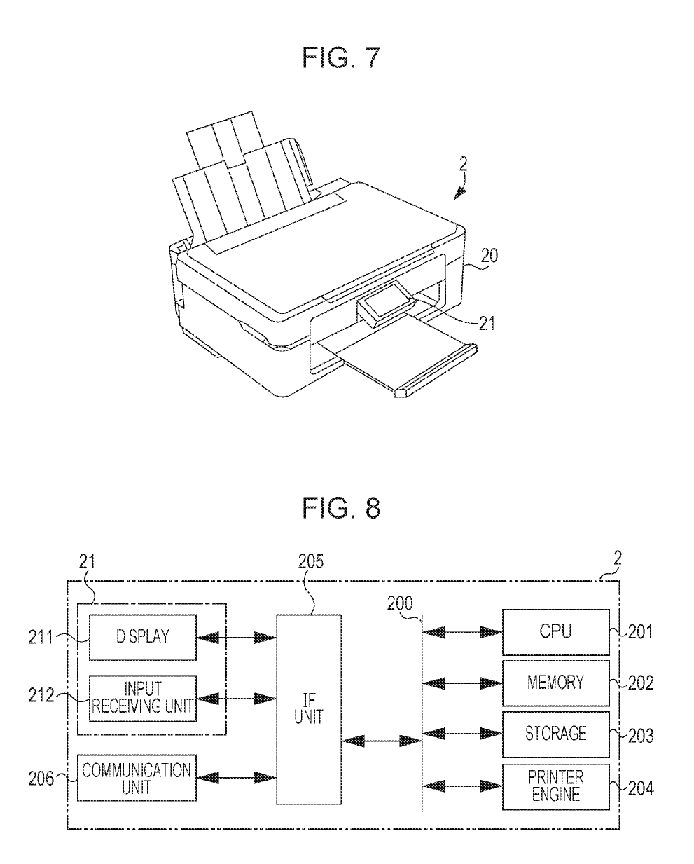

FIG. 7 is a view illustrating the exterior of an electronic apparatus according to a second embodiment of the present invention. FIG. 8 is a block diagram illustrating the electrical structure of the electronic apparatus. The electronic apparatus of this embodiment is a printer 2 configured to perform printing on, for example, a recording media such as paper or film by an ink jet system. The printer 2 has a configuration in which a touch panel 21 is provided to a front surface of a housing 20 accommodating a printer engine 204 which will be described later.

The printer 2 includes a CPU 201, memory 202, storage 203, a printer engine 204, an interface (IF) unit 205, and other elements, and these elements are connected to be able to communicate with each other via an internal bus 200 in the housing 20.

The CPU 201 runs a predetermined control program to enable the elements of the apparatus to perform prescribed operations, thereby performing a printing operation. The memory 202 stores various data such as data required to perform processes and intermediate data generated by the CPU 201. The storage 203 has a larger storage capacity than the memory 202 and enables non-volatile data storage. The storage 203 stores the control program to be run by the CPU 201 and various types of data such as image data provided by an external device such as a computer and an external memory.

The printer engine 204 includes hardware for forming an image on the recording media using ink in an ink cartridge (not shown). Since known configuration can be used as such a hardware configuration, detailed description thereof will be omitted.

The IF unit 205 controls exchange of information between the printer 2 and a user and the external device. Specifically, the touch panel 21 and a communication unit 206 are connected to the IF unit 205. The touch panel 21 includes a display unit 211 configured to display an image and an input receiving unit 212 configured to output a signal corresponding to a touch position on a display surface of the display unit 211 to accept a touch operation. Contents of an image to be displayed on the display unit 211 are determined by image data received from the CPU 201 provided via the IF unit 205. Moreover, the signal output from the input receiving unit 212 and relating to the touch position is transmitted via the IF unit 205 to the CPU 201. With this configuration, the CPU 201 can grasp the content of an input operation performed by a user on the touch panel 21. The communication unit 206 has a wired or wireless communication function and communicates with an external device via a suitable form of communication such as the Internet or via wireless communication.

The printer 2 having the above-described configuration enables a user to set an operation condition of each elements of the printer 2 via the touch panel 21. That is, menu items to operate the operation condition of the printer 2 are displayed on the display unit 211 of the touch panel 21, and when a user touches the location in which an item desired by the user is displayed, the input operation is received by the input receiving unit 212 to set the operation condition. Moreover, in response to a request by a user, a help screen describing a method for operating the printer 2 is displayed on the display unit 211. Document data to display these screens is stored in the storage 203 in advance, and the CPU 201 accesses the storage 203 as necessary to read the document data.

With this configuration, the touch panel 21 having a relatively small size is used due to limitations by an installation space and apparatus cost. Therefore, all information cannot be displayed on one screen at the same time to a user. Thus, in the present embodiment, the CPU 201 executes a similar process to the CPU 101 of the first embodiment so as to enable an image to be enlarged or reduced on the touch panel 21. In this way, various types of information relating to the operation of the printer 2 can be displayed to a user on a relatively small touch panel 21.

### Others

As described above, in the above-described embodiments, the CPU 101 and the CPU 201 serve as the “image creating units” of the invention, and the display units 111 and 211 serve as the “display unit” and the “display” of the invention. Moreover, the input receiving units 112 and 212 serve as the “reception units” of the invention. Moreover, in the above-described embodiments, the original-size image Ia corresponds to the “first image” of the invention, and the reduced image Ic2 corresponds to the “second image” of the invention. The reduction ratio of the reduced image Ic2 based on the original-size image Ia as a reference, that is, the display scale factor corresponds to the “reduction ratio” of the invention.

Moreover, in the first embodiment, when the CPU 101 acquires the document data from the storage 103, the storage 103 serves as the “data providing unit” of the invention. On the other hand, when the CPU 101 acquires the document data from an external device, the IF unit 105 and the communication unit 106 integrally serve as the “data providing unit” of the invention. Moreover, in the second embodiment, the storage 203 corresponds to the “data providing unit” of the invention, and the printer engine 204 corresponds to the “print unit” of the invention.

The invention is not limited to the above-described embodiments, but can also have various modifications added to the item described above as long as it does not stray from the gist. For example, the two embodiments are a tablet terminal apparatus and a printer as the “electronic apparatuses” of the invention. However, application targets of the invention are not limited to these examples, but the invention is also applicable to any types of electronic apparatuses including a display, thereby providing notable effects.

Moreover, for example, the above-described embodiments are electronic apparatuses each including a touch panel which serves as both the “display unit” and the “reception unit” of the invention, but the display unit and the reception unit may be separately provided. For example, a display panel as the “display unit” and an operation button or a switch as the “reception unit” may be combined with each other. Moreover, the invention is applicable to any electronic apparatus including no component corresponding to a reception section as long as the reduction ratio of an image can be specified in any form.

Moreover, for example, in the above-described embodiments, priority objects are selected and a difference is made in reduction ratio between objects in generating display data of an image having a display scale factor of less than 1, that is, an image corresponding to a reduced image of an original-size image. Instead of this, when the display scale factor is less than a prescribed value (or less than or equal to the prescribed value) which is less than 1, the priority objects may be introduced. In such a configuration, in a case of reduction by a display scale factor slightly less than 1, it is possible to make no difference in reduction ratio between objects.

Moreover, the invention is applicable to three-dimensionally displayed objects. For example, an observation direction may be changed to change attribute information and/or given points. With this configuration, a user changes the observation direction and performs the enlargement/reduction operation of the objects, which enables easy extraction of only information considered to be useful.

What is claimed is:

1. An electronic apparatus, comprising:
a data providing unit configured to provide document data including a plurality of objects;
an image creating unit configured to generate image data including at least one of the objects arranged on an image plane based on the document data; and
a display unit configured to display the image data, wherein
the image creating unit generates the image data corresponding to a first image and the image data corresponding to a second image which corresponds to an image obtained by reducing the first image by a prescribed reduction ratio, and
the image creating unit sets a size of a priority object selected from the objects based on an attribute in the document data of the second image to be greater than a size obtained by multiplying a size of the priority object in the first image by the reduction ratio.

2. The electronic apparatus according to claim 1, wherein
the image creating unit sets a size of at least some of the objects other than the priority object in the second image to be smaller than a size obtained by multiplying a size of the at least some objects of the first image by the reduction ratio.

3. The electronic apparatus according to claim 1, wherein
the image creating unit hides at least some of the objects other than the priority object in the second image.

4. The electronic apparatus according to claim 1, further comprising:
a reception unit configured to receive an input operation to change the reduction ratio, wherein
the image creating unit sets the reduction ratio according to the input operation to the reception unit.

5. The electronic apparatus according to claim 4, further comprising:
a touch panel serving as the reception unit and the display unit, wherein
the input operation is a pinch zoom operation performed on the touch panel.

6. The electronic apparatus according to claim 1, wherein
the document data includes text as the objects, and
the image creating unit defines a portion of the text selected based on text attributes in the document data as the priority object.

7. The electronic apparatus according to claim 1, further comprising:
a printer unit configured to execute a printing operation, wherein
the data providing unit stores the document data corresponding to a guidance screen explaining operation of the printer unit.

8. A display method of an electronic apparatus, comprising:
generating image data in which at least some objects included in document data are arranged on an image plane; and
displaying an image corresponding to the generated image data on a display, wherein
generation of the image data corresponding to a first image and the image data corresponding to a second image which corresponds to an image obtained by reducing the first image by a prescribed reduction ratio is possible and
a size of a priority object selected from the objects based on an attribute in the document data of the second image is set to be greater than a size obtained by multiplying a size of the priority object in the first image by the reduction ratio.
